(19) United States
(12) Patent Application Publication
(10) Pub. No.: US 2026/0200329 A1
(43) Pub. Date: Jul. 16, 2026

(54) ELECTRICAL INSTALLATION WITH MEANS FOR EXTINGUISHING SERIES ELECTRIC ARCS, IN PARTICULAR IN A CONTACTOR

(71) Applicant: SAFRAN ELECTRICAL & POWER, Blagnac (FR)

(72) Inventor: Eric GUILLARD

(73) Assignee: SAFRAN ELECTRICAL & POWER, Blagnac (FR)

(21) Appl. No.: 19/136,987

(22) PCT Filed: Dec. 6, 2023
(86) PCT No.: PCT/FR2023/051941

§ 371 Date: Jun. 9, 2025

(30) Foreign Application Priority Data
Dec. 14, 2022 (FR) FR2213373

(51) Int. Cl. B60L 3/04; B60L 50/60; B64D 31/16; H02H 1/04; H02H 3/08

(52) U.S. Cl. CPC B60L 3/04; B60L 50/60; B64D 31/16; H02H 1/043; H02H 3/08; B60L 2200/10; B60L 2270/20

(57) ABSTRACT

The electrical installation for an aircraft is provided. The electrical installation can include: a power source; an electrical load; first and second power supply lines connecting the electrical load to the power source in order to supply electric power to the electrical load; and a double-break power contactor located on the first power supply line, the power contactor having two fixed contacts and one movable contact The installation can further include: a branch in parallel with the first power supply line connected between the movable contact and a point of the first power supply line; and a device for opening one of the power supply lines on the basis of a current flowing in the branch.

### TECHNICAL FIELD OF THE INVENTION

The present invention relates to an electrical installation with means for interrupting a series electric arcs produced in particular in a contactor, as well as to an aircraft comprising such an electrical installation.

### TECHNICAL BACKGROUND

Vertical Take Off and Landing (VTOL) airplanes and Conventional Take Off and Landing (CTOL) airplanes with electric or hybrid propulsion represent a future market with significant prospects and demand for intra-and inter-urban transport of goods and people.

These different platforms are powered by one or more electric motors, the number varying according to the aircraft architecture. These electric propulsion systems use ever higher voltage levels.

The failure modes of these systems show that the appearance of a series electric arcs can have serious consequences on the airplane structures if the system is not cleared (i.e. stopped).

In an aircraft using propulsive electrical power, one or more of the following functions may be used to provide power to the aircraft:
an energy storage system, for example in the form of batteries,
a Battery Management System (BMS) designed to manage the charging and discharging of battery cells,
a distribution and protection equipment for the supply chain, and
a propulsion converter unit designed to convert electrical energy into mechanical energy.

The detection of the series electric arcs in an onboard power supply chain, particularly at the level of a contactor, often requires the use of elements dedicated to this function, which can be complex.

It may therefore be desirable to provide an electrical installation with means for clarifying series electric arcs, which allows at least some of the aforementioned problems and constraints to be overcome.

### SUMMARY OF THE INVENTION

An electrical installation for an aircraft is therefore proposed, comprising:
a power source;
an electrical load;
first and second power supply lines connecting the electrical load to the power source to supply electrical power to the electrical load; and
a double-break power contactor located on the first power supply line, the power contactor comprising two fixed contacts and one movable contact;
   characterized in that it further comprises:
a branch in parallel with the first power supply line, connected between the movable contact and a point of the first power supply line; and
a device for opening one of the power supply lines on the basis of a current flowing in the branch.

The invention thus allows the detection of the occurrence of a series electric arc between the movable contact and the point of the first power supply line, in particular on the power contactor. In fact, the series electric arc causes a voltage drop, resulting in a current flowing in the parallel branch. In response to this current, the opening device opens one of the power supply lines, which clears the series electric arcs, i.e., stops it. In addition, when the power contactor is open, the branch is also open, thus preventing current flow that could cause the opening device to trip unexpectedly.

The invention may also comprise one or more of the following optional characteristics, in any technically possible combination.

Preferably, the opening device comprises a pyroswitch located on one of the power supply lines, the pyroswitch comprising an initialization resistor located on the branch.

Also preferably, the pyroswitch is designed to cut the first power supply line outside the segment of the first power supply line extending between the power contactor and the point.

Also preferably, the opening device comprises a power contactor located on the first electrical line or on the second electrical line.

Also preferably, the detection device also comprises a timing resistor located on the branch.

Also preferably, the electrical installation also comprises:
a second branch connected between:
   a second point on the first power supply line, located between the power contactor and the first point on the first power supply line, and
   a point on the first branch, located between the movable contact and at least one part of the opening device located on the first branch; and
a timing resistor on at least one of the second branch and the segment of the first branch extending from the movable contact to the point on the first branch.

Also preferably, the electrical installation includes a fuse on the first power supply line, located between the first and second points of the first power supply line.

Also preferably, the electrical installation comprises a timing resistor on at least one of the second branch and the segment of the first branch extending from the movable contact to the point of the first branch, these two timing resistors having different values.

Also preferably, the electrical installation also comprises a current backflow prevention device designed to prevent current flow in the second branch when a series electric arc occurs between the movable contact and the second point of the first power supply line.

Also preferably, the electrical load comprises an electrical machine for driving an aircraft fan.

An aircraft comprising an electrical installation according to the invention is also proposed.

### BRIEF DESCRIPTION OF THE FIGURES

The invention will be better understood with the aid of the following description, given only by way of example and made with reference to the attached drawings wherein:

FIG. 1 is an electrical diagram of an example of an electrical installation according to the invention,

FIG. 2 is a block diagram of an example of a method for operating the installation shown in FIG. 1,

FIG. 3 shows the electrical diagram in FIG. 1 in the event of a series electric arc following the melting of a fuse in the electrical installation,

FIG. 4 shows the electrical diagram of FIG. 1 in the event of a series electric arc occurring in a power contactor in the electrical installation,

FIG. 5 illustrates curves for non-damage to a power supply line and fuse tripping,

FIG. 6 shows the electrical diagram of FIG. 1 in the event of series electric arcs occurring in a power contactor of the electrical installation when it is opened, and

FIG. 7 is an electrical diagram of another example of an electrical installation according to the invention, and

FIG. 8 is an electrical diagram of another example of an electrical installation according to the invention.

### DETAILED DESCRIPTION OF THE INVENTION

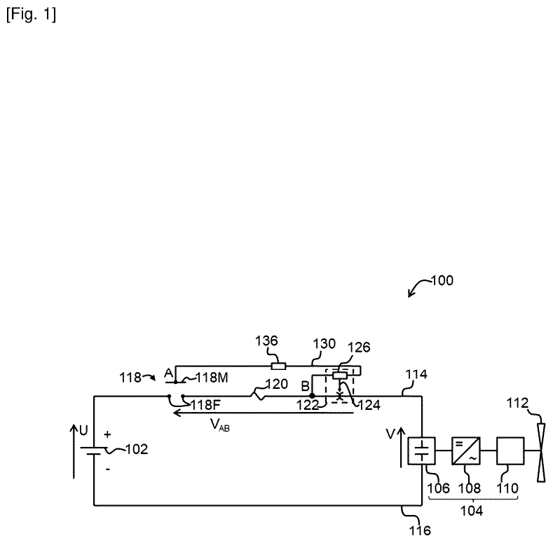

With reference to FIG. 1, an example of an electrical installation 100 according to the invention will now be described.

The electrical installation 100 is designed to form part of an aircraft.

The electrical installation 100 firstly comprises a power source 102, for example a DC power source such as a battery. The power source 102 is thus designed to supply a voltage U, which may be DC.

The electrical installation 100 also comprises an electrical load 104 designed to receive a DC voltage V. For example, the electrical load 104 comprises a stage 106 for smoothing the DC voltage V, a DC/AC voltage converter 108 for converting the smoothed DC voltage V into an AC voltage and an electrical machine 110 for driving a fan 112 of the aircraft (for example a propeller) from the AC voltage.

The electrical installation 100 also comprises first and second power supply lines 114, 116 each connecting the electrical load 104 to the power source 102 to supply electrical power to the electrical load 104 from the power source 102.

The electrical installation 100 also comprises a power contactor 118 located on one of the power supply lines 114, 116. The power contactor 118 is double-break and comprises two fixed contacts 118F and a movable vane 118M acting as a movable contact designed to come into contact with the two fixed contacts 118F when the power contactor 118 is closed, and to move away from them when the power contactor 118 is open.

The electrical installation 100 also preferably comprises an arc blowing device (not shown) designed to displace and make disappear the electric arc(s) appearing between the movable contact 118M and each of the fixed contacts 118F when the power contactor 118 opens. The displacement of the electric arc(s) is achieved, for example, by applying a magnetic field, and the disappearance of the electric arc(s) is achieved, for example, by dividing the electric arc into several smaller electric arcs.

The electrical installation 100 also comprises a fuse 120 located on one of the power supply lines 114, 116.

The electrical installation 100 also comprises a device for opening one of the power supply lines 114, 116, in order to clear a series electric arc appearing between the movable contact 118M and a point B on the first power supply line 114, located for example on the side of the electrical load 104 with respect to the power contactor 118.

Preferably, the opening device is designed to be triggered once only, with no possibility of being reset. This means that it is designed to cut one of the power supply lines without being able to restore it, i.e. without being able to re-establish an electrical connection along the cut power supply line. The opening device comprises for example a pyroswitch 122 located on one of the power supply lines 114, 116. The pyroswitch 122 comprises a guillotine 124, an initialization resistor 126 and a pyrotechnic element (not shown) designed to be triggered under the effect of the heat released by the initialization resistor 126.

The purpose of triggering the pyrotechnic element is to propel the guillotine 124 so that it mechanically cuts the power supply line (the first power supply line 114 in the example shown). The initialization resistor 126 is thus designed to have a current flowing through it to heat it up and thus provide the heat required to trigger the pyrotechnic element.

The opening device also comprises a device 128 for detecting a series electric arc and activating the pyroswitch 122.

The detection device 128 thus comprises a branch 130 connected between the movable contact 118M (connection to a point A of the movable contact 118) and point B of the first power supply line 114. Preferably, the fuse 120 is located between the power contactor 118 and the point B. This allows detection of a series electric arc occurring when the power contactor 118 is opened or closed, or a series electric arc caused by damage to the first power supply line between the movable contact 118 and the point B, for example occurring as a result of melting of the fuse 120. The pyroswitch 122 may be designed to cut the first power supply line 114 outside the segment of the first power supply line 114 extending between the movable contact 118M and the point B, as illustrated in FIG. 1, but this is not mandatory.

In the case where the electrical load 104 comprises the electrical machine 110 coupled to the fan 112, the pyroswitch 122 is preferably designed to cut the first power supply line 114 as close as possible to the electrical machine 110. In fact, the latter can become a generator when it is disconnected from the power source 102 and can therefore supply other loads connected between the power supply lines 114, 116.

The detection device 128 further comprises, in series on the branch 130: a time delay resistor 136 and the initialization resistor 126 of the pyrotechnic fuse 122, the initialization resistor 126 being the last, i.e., closest to the point B.

The timing resistor 136 limits the current flowing through the initialization resistor 126 and therefore slows down the heating of the latter. This prevents the pyrotechnic fuse from being triggered by a transient series electric arc which disappears spontaneously or, thanks to the blowing device, very quickly after it appears. In some cases, in particular when the delay inherent in the initialization resistor 126 is deemed sufficient, the timing resistor 136 may be omitted.

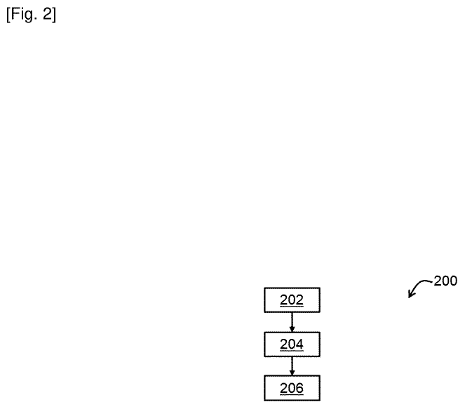

With reference to FIG. 2, an example of a method 200 for operating the electrical installation 100 will now be described.

The power contactor 118 is initially open. In this way, the electrical load 104 is disconnected from the power source 102, so that its voltage V is zero and no current flows in the power supply lines 114, 116. In addition, the connection of the branch 130 to the movable contact 118M prevents the pyroswitch 122 from being triggered accidentally. Indeed, if the branch 130 were connected directly to the first power supply line 114 on the other side of point B from the power contactor 118, the voltage U present between points A and B would cause a current to flow in the branch 130 and therefore in particular in the initialization resistor 126 which could lead to the pyroswitch 122 being triggered.

During a step 202, the power contactor 118 is closed. The power source 102 supplies power to the electrical load 104 so that a current flows through the power supply lines 114, 116.

In the absence of series electric arcs, the voltage drop on the first power supply line 114 is very low. More specifically, the voltage drop across the power contactor 118 is, for example, less than 150 mV and the voltage drop across the fuse 120 is, for example, less than 150 mV. Thus, between the movable contact 118M and the point B, there is a negligible voltage V_{AB} resulting in no current circulation in branch 130 sufficient to trigger the pyrotechnic fuse 122.

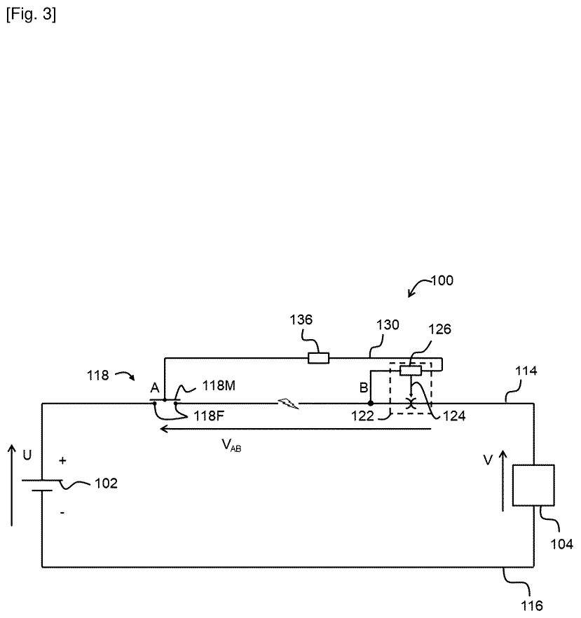

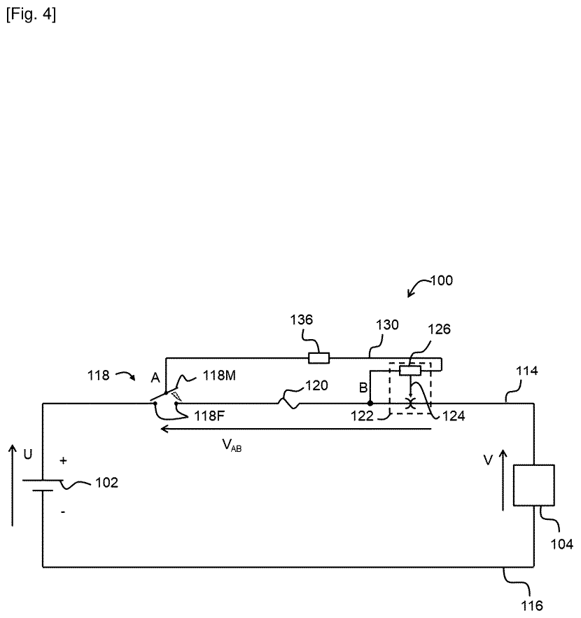

During a step 204, a series electric arc appears on the first power supply line 114, between the power contactor 118 and the point B. The series electric arc is caused, for example, by the melting of the fuse 120 and appears in place of the fuse 120, as shown in FIG. 3. Alternatively, the series electric arc can occur in the power contactor 118 if it is incorrectly closed. For example, a gap may remain between the fixed contact 118F on the side of the point B and the movable contact 118M, the series electric arc then extending into this space, as shown in FIG. 4.

As explained in André Thibault's thesis entitled “Étude des mécanismes d'entretien et de propagation d'un arc électrique de court-circuit entre câbles endommagés dans les réseaux électriques d'aéronefs”, available under the identifier tel-01804832 on the HAL platform, the series electric arc presents a voltage drop of a few volts at its onset, for example at least 15 V to 20 V.

The voltage drop of the series electric arcs is added to that of the first power supply line 114 between the power contactor 118 and the point B (the other elements having a negligible voltage drop). In addition, as the length of the series electric arc increases (for example, when the molten material of the fuse 120 falls or disintegrates), the voltage drop of the series electric arc may increase, and therefore also the voltage drop V_{AB} between the power contactor 118 and point B. The appearance of the electric arc therefore causes a current to flow in the branch 130 and in particular in the initialization resistor 126, which heats up.

During a step 206, the heat generated by the initialization resistor 126 becomes sufficiently high to trigger the pyroswitch 122, which cuts off the first power supply line 114 and thus stops the series electric arcs.

The suppression by the pyroswitch 122 of the electric arc from a trigger of fuse 120, allows to avoid reinjecting energy into the network (an effect called “windmilling”) if the pyroswitch 122 is located near the electrical load 104, in particular the electrical propulsion machine 110.

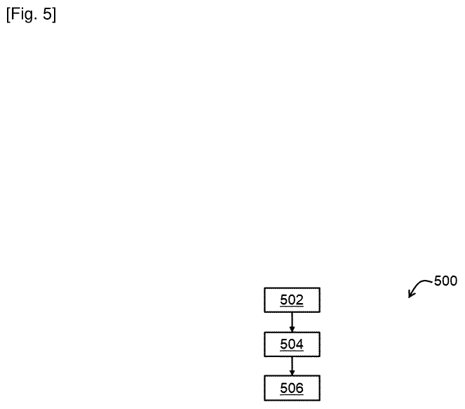

With reference to FIG. 5, an another example of a method 500 for the operation of the electrical installation 100 is now described.

The power contactor 118 is initially closed. In this way, the electrical load 104 is connected to the DC voltage source 102, so that its voltage V is substantially equal to the voltage U and a current flows in the power supply lines 114, 116.

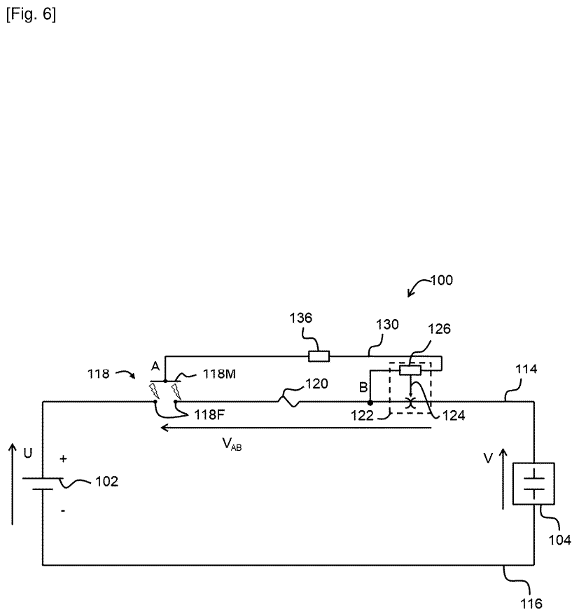

During a step 502, the power contactor 118 is opened and series electric arcs occurs between the movable contact 118M and each of the fixed contacts 118F, as shown in FIG. 6.

As a result, the series electric arc on the side of the point B has a voltage drop causing current to flow in the branch 130, in particular in the initialization resistor 126, which heats up.

When the blowing device is operating correctly, during a step 504, the electric arcs are blown, before the initialization resistor 126 reaches a temperature for triggering the pyroswitch 122. The timing resistor 136 may therefore be important to ensure that, during the blow-off time, the initialization resistor 126 does not have time to reach the trigger temperature.

On the other hand, if the electric arcs continue, at least on the side of the point B, for example because of a failure of the blowing device, during a step 506, the heat given off by the initialization resistor 126 becomes sufficiently high to trigger the pyroswitch 122 which cuts the first power supply line 114 and thus stops the series electric arcs.

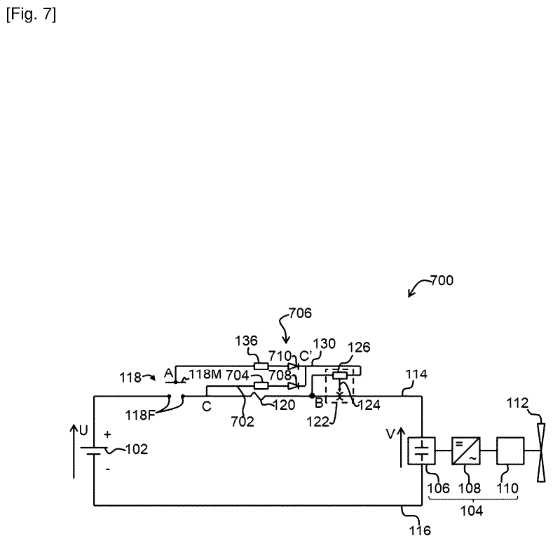

With reference to FIG. 7, a further example of an electrical installation 700 according to the invention will now be described.

The electrical installation 700 is identical to the electrical installation 100 of the previous figures, except that it comprises, in addition to the branch 130 referred to hereafter as the first branch, a second branch 702 connected between the first power supply line 114 and the first branch 130. More specifically, the second branch 702 is connected to a point C of the first power supply line 114, located between the power contactor 118 and point B. The second branch 702 is also connected to a point C′ of the first branch 130, located between the movable contact 118M and at least one part of the opening device located on the first branch, the initialization resistor 126 in the example of FIG. 1.

The electrical installation 700 then comprises a second delay resistor 704 on the auxiliary branch 702.

In this way, a series electric arc appearing on the power contactor 118 causes a current to flow in the first branch 130 through the timing resistor 136 to the initialization resistor 126. On the contrary, an electric arc appearing on the fuse 120 causes a current to flow in the second branch 702 through the delay resistor 704 to the initialization resistor 126. However, the voltage of the series electric arc can reach very different values: generally 50 V for the fuse 120 and several hundred volts (e.g. 1,000 V) for the power contactor 118. It is therefore preferable for resistors 136 and 704 to have different values, in particular for resistor 136 to be higher than resistor 704, for example at least ten times higher.

In the event of an electric arc on the power contactor 118, the current generated could flow back through the second branch 702 instead of the initialization resistor 126. To prevent this, the electrical installation 700 preferably comprises a current backflow prevention device 706 designed to prevent a current flow in the second branch 702, when a series electric arc occurs between the movable contact 118M and point C. In addition or alternatively, the current backflow prevention device 706 may be designed to prevent current flow to the movable contact 118M from point C′, when a series electric arcs occurs between the point C and point B. This current backflow prevention device 706 comprises, for example, a diode 708 on the second branch 702, passing towards point C′, and preferably a diode 710 on the first branch 130, between the movable contact 118M and the point C′, passing towards the latter.

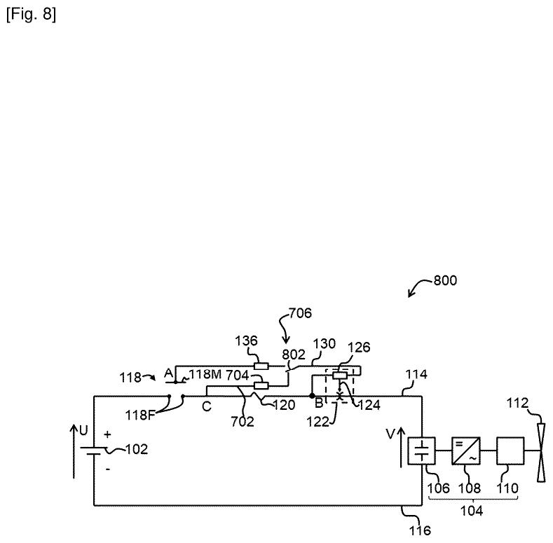

With reference to FIG. 8, a further example of an electrical installation 800 according to the invention will now be described.

The electrical installation 800 is identical to that shown in FIG. 7, except that the current backflow prevention device 706 comprises an auxiliary contact 802 coupled for example mechanically to the movable contact 118M of the power contactor 118, to connect the initialization resistor 126 to the first timing resistor 136 when the power contactor 118 is open and to the second timing resistor 704 when the power contactor 118 is closed. Preferably, the auxiliary contact 802 is designed to connect the initialization resistor 126 to the first timing resistor 136 after the power contactor 118 is open and to the second timing resistor 704 before the power contactor 118 is closed.

In conclusion, it should be noted that the invention is not limited to the embodiments described above. In fact, it will appear to the person skilled in the art that various modifications can be made to the above-described embodiments, in the light of the teaching just disclosed.

For example, the series arc could be cleared, instead of or in addition to triggering the pyrotechnic fuse 122, by opening the power contactor 118.

In the foregoing detailed presentation of the invention, the terms used should not be interpreted as limiting the invention to the embodiments exposed in the present description, but should be interpreted to include all equivalents the anticipation of which is within the reach of the person skilled in the art by applying his general knowledge to the implementation of the teaching just disclosed.

1. An electrical installation for an aircraft, comprising:
a power source;
an electrical load;
first and second power supply lines connecting the electrical load to the power source to supply electrical power to the electrical load;
a double-break power contactor located on the first power supply line, the power contactor comprising two fixed contacts and one movable contact
a branch in parallel with the first power supply line connected between the movable contact and a point of the first power supply line; and
a device for opening one of the power supply lines on the basis of a current flowing in the branch.

2. The electrical installation according to claim 1, wherein the opening device comprises a pyroswitch located on one of the power supply lines, the pyroswitch comprising an initialization resistor located on the branch.

3. The electrical installation according to claim 2, wherein the pyroswitch is configured to cut the first power supply line outside the segment of the first power supply line extending between the power contactor and the point.

4. The electrical installation according to claim 1, wherein the opening device comprises a power contactor located on the first electrical line or on the second electrical line.

5. The electrical installation according to any claim 1, further comprising a timing resistor located on the branch.

6. The electrical installation according to claim 1, further comprising:
a second branch, connected between:
a second point on the first power supply line, located between the power contactor and the first point on the first power supply line; and
a point on the first branch, located between the movable contact and at least one part of the opening device located on the first branch; and
a timing resistor on at least one of the second branch and the segment of the first branch extending from the movable contact to the point of the first branch.

7. The electrical installation according to claim 6, further comprising a fuse on the first power supply line, located between the first and second points of the first power supply line.

8. The electrical installation according to claim 6, comprising a timing resistor on at least one of the second branch and the segment of the first branch extending from the movable contact to the point of the first branch, these two timing resistors having different values.

9. The electrical installation according to claim 6, further comprising a current backflow prevention device configured to prevent current flow in the second branch when a series electric arc occurs between the movable contact and the second point of the first power supply line.

10. The electrical installation according to any claim 1, wherein the electrical load comprises an electrical machine for driving a fan of the aircraft.

11. An aircraft comprising an electrical installation according to claim 1.
